(19) United States
(12) Patent Application Publication
(10) Pub. No.: US 2012/0208292 A1
(43) Pub. Date: Aug. 16, 2012

(54) FLUORESCENT MEASUREMENT IN A DISPOSABLE MICROFLUIDIC DEVICE, AND METHOD THEREOF

(76) Inventors: William Lewis, Belmont, MA (US); James E. Flaherty, Attleboro, MA (US); Eugene K. Achter, Lexington, MA (US); Dirk Kurowski, (US)

(21) Appl. No.: 13/326,999

(22) Filed: Dec. 15, 2011

Related U.S. Application Data
(63) Continuation-in-part of application No. PCT/EP2011/058635, filed on May 26, 2011.

(30) Foreign Application Priority Data
May 31, 2010 (EP) 10005631.6

(51) Int. Cl. G01N 21/64

(52) U.S. Cl. 436/501; 422/69

(57) ABSTRACT

A device including a shallow chamber for analyzing a target analyte in a body fluid using the signal generated by fluorescent detector molecules specific for the target analyte and attenuating the signal emitted by fluorescent detector molecules non-specifically bound to the surfaces of the chamber by a signal attenuating dye; and method thereof.

### CROSS-REFERENCE TO RELATED APPLICATIONS

This application is a continuation-in-part of International Application No. PCT/EP2011/151250, filed May 26, 2011, which claims priority to European Patent Application No. EP10005631.6, filed May 31, 2010, the entire contents of each are incorporated by reference in their entirety into the present application.

This application and related application entitled, “Attenuating dye for interrogating multiple surfaces, and method thereof”, Attorney Docket No. INL-112 (43057-00112), incorporated by reference in its entirety, are filed of even date.

### NAMES OF THE PARTIES TO A RESEARCH AGREEMENT

One or more of the inventions disclosed and/or claimed herein were made 1) on behalf of Instrumentation Laboratory Company and Microparts Gmbh, parties to a joint research agreement as defined in 35 U.S.C. §103(c)(3) that was in effect before the date the claimed inventions were made, and, 2) as a result of activities undertaken within the scope of the joint research agreement.

### FIELD OF THE INVENTION

The present invention relates to the quantitative optical detection of target biological analytes of the type in a biological specimen, such as a patient body fluid. The present invention is more specifically related to a device and method for achieving a true and specific optical signal emitted from fluorescently labeled target analytes. The true and specific optical signal is achieved by attenuating the interfering fluorescence emitted from fluorescent detector molecules that are non-specifically bound to the luminal surface of an assay chamber. The optical signal accurately reflects the concentration of the target analyte in the biological specimen when assayed in an assay chamber of a microfluidic device according to the invention described herein.

### BACKGROUND OF THE INVENTION

Fluorescent measurement of a target analyte in biomedical assays may be conducted in an assay chamber in which one portion of the chamber has an optically clear surface that is coated with binding partners specific for a target analyte of interest in a biological sample. In a cell-based assay, cells are grown on the optically clear luminal surface of a cell assay vessel. In cell based assays the vessel must be sufficiently large, i.e., capable of holding sufficient fluid (often greater than 100 microliters), to maintain the cells with appropriate needs such as nutrition, oxygen, and waste removal. The optically clear luminal surface of such cell-based assay vessels is specifically treated to allow the cells to attach to its luminal surface. Other luminal surfaces of the cell assay vessel are treated with blocking agents to minimize non-specific binding to these other luminal surfaces. Cell membrane potential changes, for example, may be assayed based on fluorescence changes of membrane potential-sensitive dyes which interact with the cells to emit fluorescent signals. Fluorescence is optically measured by an optical detector through the optically clear luminal surface, typically the bottom surface, of the vessel.

With respect to fluorescent measurement of a target biological analyte not bound to a cell in a biological sample, the biological sample suspected of having the target analyte of interest typically is mixed in a solution with fluorescent detector molecules having a binding partner that is specific for and binds to the target analyte. The biological sample with the target analyte of interest bound to the fluorescent detector molecule flows as a solution into the lumen of an assay chamber having a portion that is optically clear. The luminal surface of the optically clear portion is coated with binding partners of the target analyte. The target analyte in the biological sample binds to the binding partner on the optically clear surface bringing with it the fluorescent detector molecule.

In another typical assay format for detecting target analytes, the biological specimen is introduced (with or without first mixing with an appropriate assay reagent) into the assay chamber such that any analytes will be specifically bound to the binding partners on the optically clear luminal surface. Following an appropriate incubation period, the chamber is washed to remove unbound analyte and specimen components and refilled with fluorescent detector molecules. After a second appropriate incubation period to allow binding of the detector molecules to target analyte, if present on the surface, the chamber is again washed to remove unbound fluorescent detector molecules.

A typical problem encountered in biomedical assays of the above types is non-specific binding of fluorescent detector molecules to luminal surfaces of the chamber. Such non-specific surface binding may occur directly or indirectly by fluorescent detector molecules complexing with a biological moiety found in the sample, for example, a protein. The complex binds to luminal surfaces of the assay chamber other than to the binding partner-coated luminal surface of the optically clear surface of the assay chamber.

In a cell-based assay, similar assay steps are taken. However, washing in a cell-based assay may be undesirable because washing may disrupt cells attached to the optically clear surface of the assay vessel. Additionally, the luminal surfaces of the cell-based assay vessel, other than the optically clear luminal surface, may be treated with blocking agents such as casein, bovine serum albumin, and newborn calf serum to inhibit non-specific binding of the fluorescent detector molecule to these surfaces. This additional treatment step, i.e., blocking, in some circumstances may be undesirable in an automated assay for detecting a target anal yte because of the increased labor, cost, time and variability and reduced throughput associated with producing large numbers of test devices.

As mentioned above, typical problems encountered in diagnostic assay designs in which the assay detects the presence of a target analyte and is performed in an assay chamber, include non-specific binding of fluorescent detector molecules to surfaces other than the coated optically clear surface. This could potentially give rise to detectable fluorescence even in the absence of the target analyte, leading to a falsely positive or elevated diagnostic result. This effect is particularly problematic in a closed assay chamber where the depth of the chamber is extremely shallow, i.e., the optically clear surface is fractions of a millimeter away from the opposite chamber surface. In this chamber type, the opposite chamber surface remains accessible to the optical system that provides excitation light and collects the emitted fluorescence. Accordingly, non-specific binding and background fluorescence adulterates the actual fluorescent signal emitted from the target analyte obscuring the optical signal that would otherwise accurately reflect the quantity of target analyte in a biological sample, such as a patient body fluid.

### SUMMARY OF THE INVENTION

The present invention is directed to automated, cost-effective, high throughput solutions that minimize background fluorescence of detector molecules bound non-specifically to luminal surfaces of an assay chamber, while avoiding the problems and cost associated with blocking non-functionalized chamber luminal surfaces. In particular, background fluorescence arising from the luminal surface opposite an actively treated optically clear surface is substantially reduced, without attenuating the optical signal originating from the target analyte bound to the optically clear activated surface. The assay for measuring a specific target analyte as defined by the invention is conducted in a microfluidic device which permits extremely rapid test results while simultaneously improving assay sensitivity, and accuracy and minimizing the expenditure of costly reagents.

In one aspect, the invention relates to a device, kit, or a composition of matter for achieving a true and specific optical signal emitted from fluorescently labeled target biological analytes in an assay chamber. In one embodiment, the invention includes a microfluidic device having an assay chamber for detecting a target analyte. The assay chamber includes a first wall with at least a portion of the first wall being optically clear, an opposite wall, and a lumen. Optionally, the entire first wall is optically clear. The first wall is coated on the luminal surface with binding partners specific for a target analyte in the biological sample. The luminal surface of the opposite wall may be coated or, optionally, uncoated with binding or blocking agents.

The device, kit, or composition of matter includes a fluorescent detector molecule comprising a binding partner for the target analyte, a solution in the assay chamber comprising a dye which is capable of absorbing the light of a wavelength range selected from the group consisting of emission wavelength range, excitation wavelength range, or their combination, of any fluorescent detector molecule that is non-specifically bound to the luminal surface of the chamber. The dye may be a single standard dye selected from the group amaranth, brilliant green, erioglaucine, for example, or a combination of standard dyes.

In one embodiment, the binding partner that is coated on the luminal surface of the first wall or just the optically clear portion of the luminal surface of the first wall comprises an antibody specific for the target analyte. The binding partner of the fluorescent detector molecule comprises another antibody specific for the target analyte. Optionally, the binding partners that are coated on the luminal surface of the first wall may comprise an intermediate binding partner.

In one embodiment, the distance between the first wall and the opposite wall is in the range of about 10 microns to 5.0 millimeters, about 75 microns, about 50 microns to 200 microns, or about 70 microns to 100 microns.

In another embodiment, the composition, kit, or device includes fluorescently labeled target analyte molecules. Fluorescently labeled target analyte molecules may be useful in a competitor binding assay.

In another aspect, the invention relates to a method for attenuating non-specific fluorescence in a microfluidic device used to measure fluorescently labeled target analytes in a biological specimen. According to one embodiment of the method of the invention, a sample is introduced into the chamber lumen of the microfluidic device described above. A fluorescent detector molecule comprising a binding partner for the target analyte is introduced into the chamber lumen. Optionally, the chamber lumen may be washed. The volume of wash solution may be less than, the same as, or greater than the volume of the chamber lumen.

After introduction of the fluorescent detector molecule, a solution comprising an attenuating dye, for example, amaranth, erioglaucine, brilliant green, or combinations of standard dyes, is introduced into the chamber. The dye is capable of absorbing light of a wavelength range selected from the group consisting of emission wavelength range, excitation wavelength range, or their combination of any fluorescent detector molecule that is non-specifically bound to the luminal surface of the chamber. An optical measurement is made and is related to the target analyte concentration in the sample. Optically measuring comprises measuring an optical signal arising from the luminal surface of the first wall.

In one embodiment, the method of the invention is a competitive binding assay including the step of introducing fluorescently labeled target analyte molecules into the chamber lumen.

In a particular embodiment of the method of the invention, the sample and fluorescent detector molecule comprising a binding partner for said target analyte are mixed together before introducing the sample and the fluorescent detector molecule into the chamber. Alternatively, the lumen of the chamber is washed after introducing the sample into the chamber lumen and prior to introducing the fluorescent detector molecule into the chamber lumen. The lumen of the chamber may be washed with a wash reagent before introducing the dye. Alternatively, the lumen of the chamber is washed with a wash reagent containing the attenuating dye. The volume of the wash reagent is the same as or exceeds the volume of the chamber. In one embodiment, the washing step introduces a wash reagent through an inlet port of the chamber and removes the wash reagent through an outlet port of the chamber.

In one embodiment, the non-specifically bound fluorescent detector molecule according to the method of the invention is coupled to another molecule, e.g., a non-target analyte.

The foregoing and other features and advantages of the invention will be more apparent from the description drawings, and claims which follow.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1A is a plan view of an exemplary instrument system including a microfluidic device according to one embodiment of the invention.

FIG. 1B illustrates a top cutaway view of an exemplary assay chamber according to one embodiment of the invention.

FIG. 1C illustrates a bottom cut away view of the exemplary assay chamber illustrated in FIG. 1B.

FIG. 1D illustrates a top cut away view of another exemplary cylindrical assay chamber according to one embodiment of the invention.

FIG. 1E illustrates a bottom cut away view of the exemplary cylindrical assay chamber illustrated in FIG. 1D.

FIG. 1F illustrates a top view of an exemplary assay chamber and method of making according to one embodiment of the invention.

FIG. 2 is a diagrammatic cross-sectional view of an assay chamber without attenuating dye.

FIG. 3 is a diagrammatic cross-sectional view of an exemplary assay chamber including an attenuating dye according to one embodiment of the invention.

FIG. 4 is a perspective view of an exemplary assay chamber including an optical signal portion of a wall according to one embodiment of the invention.

### DESCRIPTION

The present invention will be more completely understood through the following description, which should be read in conjunction with the attached drawings. In this description, like numbers refer to similar elements within various embodiments of the present invention. Within this description, the claimed invention will be explained with respect to embodiments. The skilled artisan will readily appreciate that the methods and systems described herein are merely exemplary and that variations can be made without departing from the spirit and scope of the invention.

As used herein, microfluidic device shall mean devices for biological assays that utilize fluid volumes on the order of picoliters to microliters. The devices have channels and/or chambers with dimensions ranging from millimeters to micrometers.

As used herein, target biological analyte shall mean an analyte or a group of analytes of interest in a biological specimen such as but not limited to pathogens, proteins, nucleic acids, lipids, antibodies, antigens, and enzymes. For example, a group of analytes may be a plurality of proteins, for example, myoglobin, proBNP, and myosin, proteins that are useful in detecting heart failure.

As used herein, a fluorescent detector molecule shall mean any molecule, binding partner, or entity that can complex directly or indirectly with another molecule or substance and can be detected using a suitable fluorescence optic system, wherein the molecule, binding partner or entity is excited by light of an appropriate wavelength and the emitted light (at a different wavelength) is measured. The molecule, binding partner or entity may be intrinsically fluorescent or rendered fluorescent by attachment of an appropriate fluorophore.

As used herein, an attenuating dye shall mean a dye that absorbs light of a wavelength range including emission wavelength range, excitation wavelength range, or the combination of emission wavelength range and excitation wavelength range of any fluorescent detector molecule.

As used herein, a binding partner shall mean a molecule, for example, an antibody which binds specifically to a target biological analyte, or an intermediate in a binding cascade, for example, where strepavidin is coated onto a surface as an intermediate binding partner, and the strepavidin then binds to biotin which has been conjugated to an antibody that is a specific binding partner for a target biological analyte.

As used herein, background fluorescence shall mean fluorescence that has not originated from a fluorescent detector molecule bound to a target analyte of interest.

In one aspect, the invention relates to a disposable microfluidic device for optical measurement of a target biological analyte in a biological specimen such as, but not limited to, body tissues, or a patient body fluid, for example, blood, serum, plasma, urine, sputum, cerebrospinal fluid, joint fluid, digestive fluid, tissue aspirates, exudates, and transudates.

Embodiments of the invention relate to an apparatus, kit, composition of matter, or method, for example, an immunoassay method, for detecting target analytes in an assay chamber of a microfluidic device.

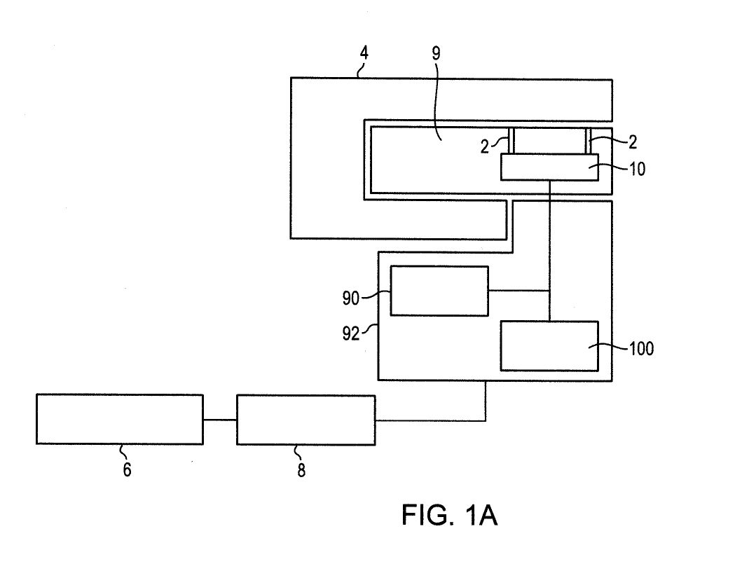

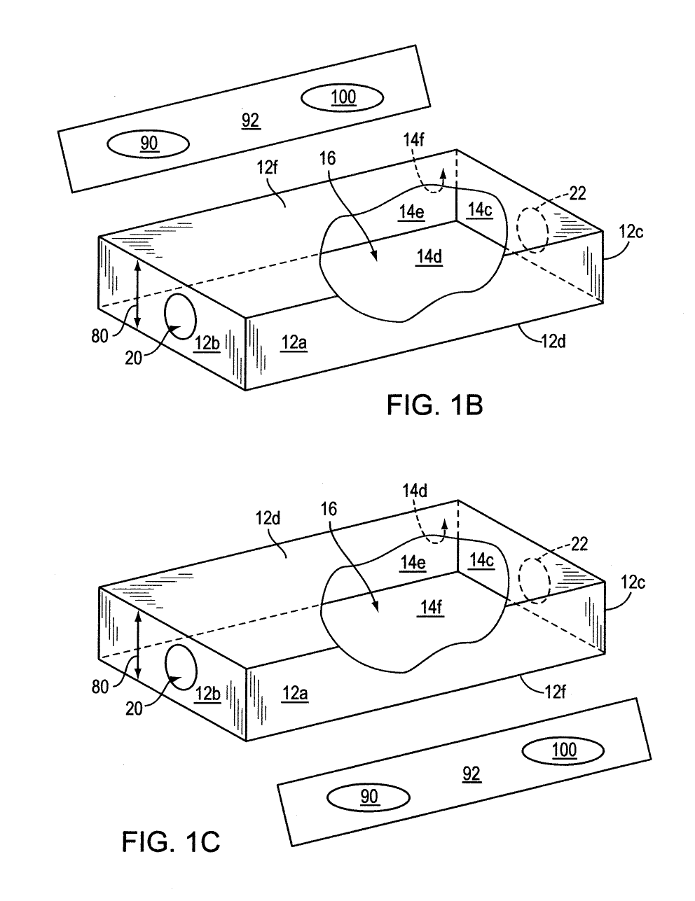

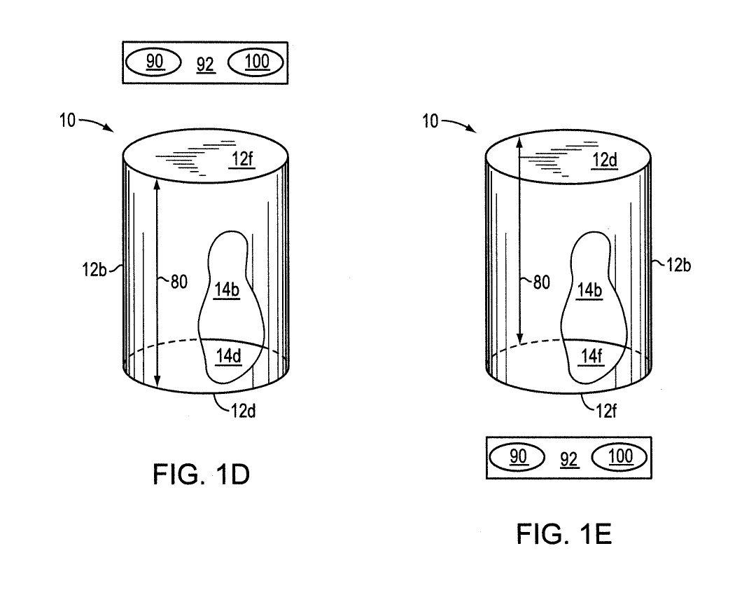

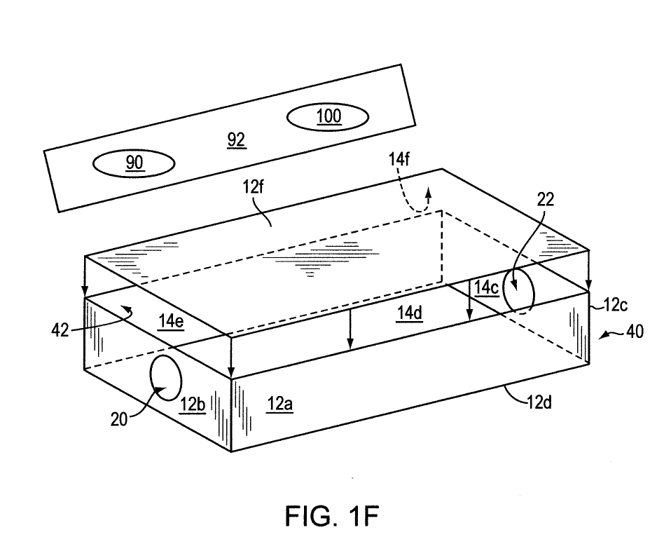

FIGS. 1A-F are exemplary embodiments of a disposable microfluidic device and instrument system according to the invention that has been developed for sensitive, accurate, cost-effective, and automated diagnostic testing of a target analyte of interest and generates rapid test results. In one embodiment, referring to FIG. 1A, the instrument system includes a microfluidic device 9 having an assay chamber 10 and fluid conduits 2, a microfluidic device holder 4, microprocessor 6, electronics 8, and an optical system 92 comprising an optical source 90 and an optical detector 100 for measuring optical signals such as optical signals generated by a fluorescent detector molecule bound to a target analyte in an assay chamber.

Referring to FIG. 1B, in one embodiment, the microfluidic device includes a rectangular assay chamber 10 which has 6 walls 12ₙ, specifically, 12a, 12b, 12c, 12d, 12e, and 12f, surrounding a chamber lumen 16. The assay chamber 10 is capable of holding a fluid when any wall could be the wall closest to the source of gravitational pull. In other words, following assembly, the chamber 10 is completely enclosed on all sides with the exception of optional ports, for example, inlet or outlet ports. In one embodiment, the chamber 10 may be a channel with optional inlet and/or outlet ports at the channel ends. The shape of the chamber 10 of the microfluidic device is not limited by the shapes illustrated in the appended figures.

Each wall 12a-12f of the chamber 10 has a luminal surface 14 adjacent the lumen 16. In one embodiment according to the invention, the chamber 10 has an inlet port 20 and an outlet port 22.

An active, optically clear wall portion is positioned within wall 12f, or optionally, as illustrated in FIG. 1B, the entire wall 12f is optically clear. The luminal surface 14f of the wall 12f, or optionally only the optically clear portion of wall 12f is activated by coating the surface with binding partners specific for a target analyte of interest. The walls 12d and 12f may be planar or may have one or more radii. In one embodiment, the chamber wall 12d that is opposite to the optically clear wall 12f is substantially parallel to, 0 to 45 degrees, 0 to 10 degrees, or 10 to 45 degrees, for example, relative to the plane of the optically clear wall 12f. Alternatively, the luminal surface of chamber wall 12d is substantially parallel to, 0 to 45 degrees, 0 to 10 degrees, or 10 to 45 degrees, for example, relative to the plane of the luminal surface of optically clear wall 12f. In one embodiment, the luminal surface 14 of the chamber walls 12a-12e other than the luminal surface 14f of the optically clear wall 12f are uncoated with binding partners or with blocking agents or any other agents prior to initiation of an assay that would otherwise block non-specific binding to the luminal surfaces of these walls.

The assay chamber 10 may be made from a polymer, for example, but not limited to, polystyrene.

Referring to FIGS. 1B-1C, in a particular embodiment according to the invention, the assay chamber 10 is substantially rectangular with an optically clear wall 12f (or portion thereof) and a wall 12d opposite the optically clear wall 12f. The distance 80 between the luminal surface 14f of the optically clear wall 12f and the luminal surface 14d of the wall 12d opposite the optically clear wall 12f is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns. The chamber lumen 16 is bounded and enclosed by the walls 12a-12f including the optically clear wall 12f and the wall 12d opposite the optically clear wall of the chamber 10. The walls other than the optically clear wall may be made from a light blocking material, for example, a black plastic. Alternatively, the walls may be optically clear.

Referring to FIGS. 1D-1E, in another embodiment according to the invention, assay chamber 10 is substantially cylindrical with wall 12f and wall 12d at opposite ends of the cylindrical chamber 10, and wall 12b joining wall 12f and 12d. Wall 12f of the chamber 10 is optically clear or, optionally, a portion of wall 12f is optically clear. The chamber wall 12d that is opposite to the optically clear wall 12f is substantially parallel, 0 to 45°, 0 to 10°, or 10 to 45° relative to the plane of the optically clear wall 12f. Alternatively, the luminal surface of chamber wall 12d is substantially parallel, 0 to 45 degrees, 0 to 10 degrees, or 10 to 45 degrees, for example, relative to the plane of the luminal surface of optically clear wall 12f.

Referring still to FIGS. 1D-1E, the luminal surface 14f of the optically clear wall 12f or a portion of the luminal surface wall 12f of the cylindrical chamber 10 is activated by coating the surface with binding partners specific for a target analyte of interest by standard methods known to the skilled artisan. In one embodiment, the luminal surface of the walls 12b and 12d are uncoated with binding partners or with blocking agents or any other agents prior to initiation of an assay that would otherwise block non-specific binding to the luminal surfaces of these walls. The distance 80 between the luminal surface 14f of the optically clear wall 12f and the luminal surface 14d of the wall 12d is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns.

The chamber may assume other shapes (e.g. shapes with curved side portions as opposed to orthogonal edges may facilitate optimal fluidic properties when introducing and removing solutions from the chamber), a channel for example, and is not limited to the illustrated rectangular or cylindrical shapes. The walls other than the optically clear wall may be made from a light blocking material, for example, a black plastic. Alternatively, the walls may be optically clear.

Referring to FIG. 1F, in one embodiment of the microfluidic device for detecting target analytes in a biological specimen according to the invention, the chamber 10 is assembled from parts into a single integrated chamber 10. For example, in one embodiment, a first chamber part is a shallow well 40 made from a polymeric material and having a wall 12d at the bottom of the shallow well 40, an open face 42 at the top of the shallow well, and well side walls 12a, 12b, 12c and 12e. The shape of the well 40 is not limited to rectangular but may be oval, circular, or other shapes, for example.

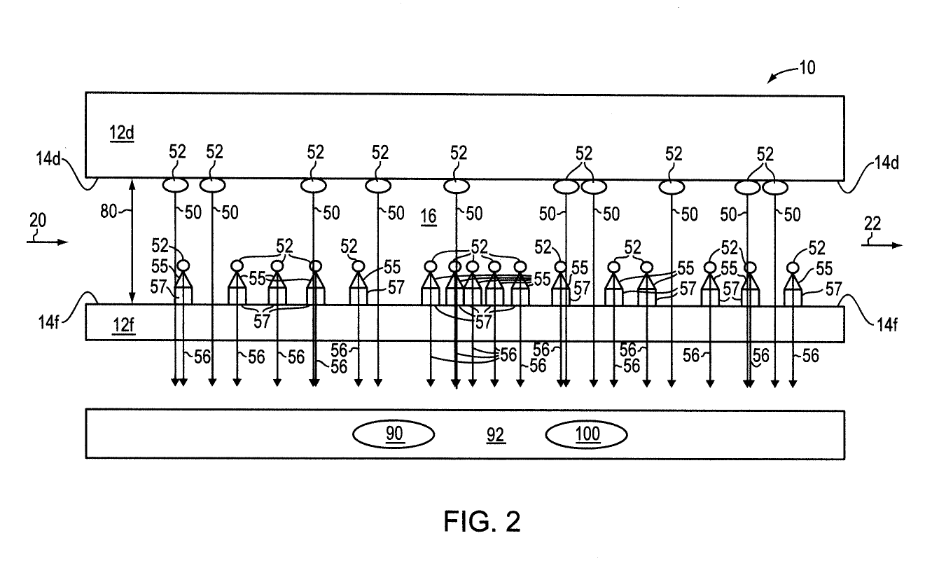

The depth of the shallow well 40 is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns. An optically clear, planar wall 12f or a wall with an optically clear portion, with dimensions that correspond substantially to the open face 42 of the shallow well 40 forms a second chamber part to be joined to the shallow well 40 to form the assay chamber 10. The optically clear wall 12f, or optionally, a portion of wall 12f of the assay chamber 10 is activated by coating the surface on one side of the wall with binding partners, defined above, for the target analyte of interest (see, e.g., FIG. 2). The binding partner coated on the surface may be, but is not limited to, for example, polyclonal or monoclonal antibodies and fragments thereof specific for a target analyte, other proteins, lectins, antibodies, oligonucleotides, protein biomarkers, aptamers, receptors, protein A, protein G, biotin, or strepavidin. The coated surface of the optically clear wall 12f is placed face down on the open face 42 of the shallow polymeric well 40 such that the coated surface is on the luminal side of the newly formed chamber 10.

The optically clear wall 12f is affixed to the top of the walls of the shallow polymeric well 40 by adhesives, heat bonding, ultrasonic welding, or other methods of permanent attachment. Optionally, the luminal surfaces 14 of the shallow well portion 40 of the chamber 10, including the luminal surface 14d of the wall 12d at the base of the shallow well 40, are not treated with any agents prior to initiation of an assay, such as blocking agents, for example, but not limited to the blocking agents casein, bovine serum albumin, and newborn calf serum.

Referring to FIG. 2, chamber 10, as described above, is readied for an assay. Chamber 10 is filled with the biological sample suspected of having the target analyte of interest. After an appropriate incubation period to allow binding of target analytes to the binding partners on the optically clear wall, the chamber lumen 16 is washed by introducing a volume of wash solution through the inlet port 20 that exceeds or is equal to the volume of the chamber lumen. The wash solution may be removed through outlet port 22. The fluorescent detector molecules with binding affinity for the target analytes are added to the chamber lumen and incubated for sufficient time to allow binding to occur. The chamber is again washed prior to optical detection to remove unbound fluorescent detector molecules. Optionally, the fluorescent detector molecules with binding affinity for the target of interest may be pre-mixed with sample. The mixture is then introduced into the chamber, followed by washing the chamber lumen, which is followed by optical detection.

In one embodiment according to the invention, the binding partners of the fluorescent detector molecules that are mixed with the biological sample are different than the binding partners for the target analyte coated on the luminal surface of the optically clear wall. Alternatively, the binding partners integral to the fluorescent detector molecules and the binding partners coated on the luminal surface may be the same, for example, when the target analyte is multivalent. In some cases, the binding partners may be purposefully designed to bind to a group of closely related target analytes, for example to detect all members of the distinct, but closely related subtypes of HIV viruses. Furthermore, the binding partners may be intermediates in a binding cascade, for example where streptavidin is coated onto the surface as an intermediate binding partner. Streptavidin then binds to biotin which has been conjugated to an antibody that is specific for the analyte of interest. The target analyte in the sample binds to the binding partner of the fluorescent detector molecules when the target analyte and binding partner are contacted in solution, thereby forming a fluorescently labeled target analyte.

For optical detection, excitation light from an optical source 90 of the instrument system is directed through the optically clear wall 12f or a portion of the optically clear wall 12f of the assay chamber 10 to excite fluorescence 56 of the fluorescent detector molecules 52 bound to the target analytes 55 which in turn are bound to the binding partners 57 on the luminal surface 14f of the optically clear wall 12f. Fluorescence 50 detected by an optical detector 100 from fluorescent detector molecules 52 non-specifically bound to the untreated luminal surfaces of portions of the assay chamber, the opposite wall luminal surface 14d in particular, is unwanted background fluorescence. The background fluorescence 50 overlaps the fluorescence 56 emitted from the target analyte bound 55 to the binding partners 57 on the luminal surface 14f of the optically clear wall 121 of the assay chamber 10. Thus, without a modification of the above chamber and method discussed below, the optical signal received by the optical detector includes a background contribution that is not related to the concentration of the target analyte. Accordingly, sensitivity and accuracy of the assay are compromised.

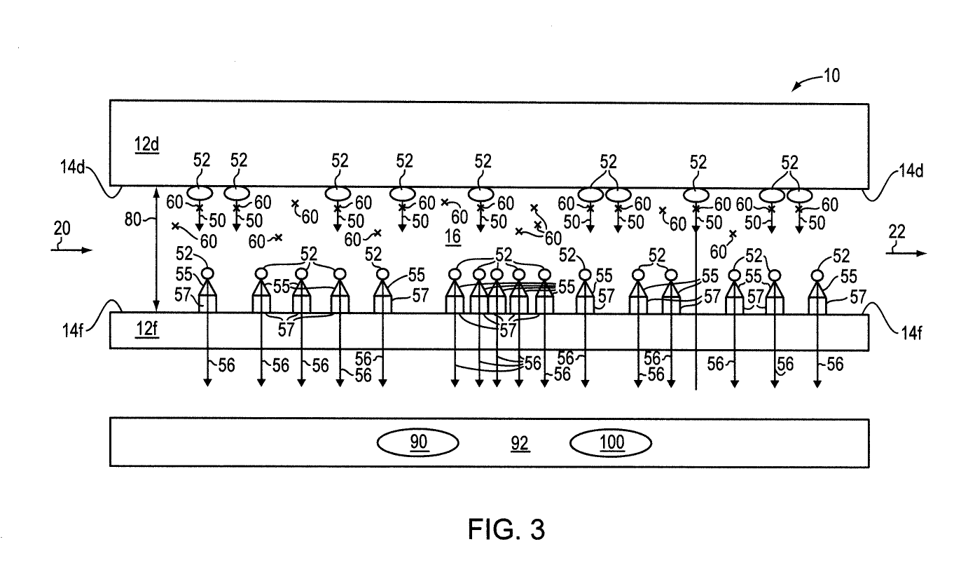

Referring to FIG. 3, in the assay chamber of a microfluidic device according to the invention discussed above, the efficiency of fluorescence excitation and collection from the non-treated luminal surface 14d of the opposite wall 12d of the assay chamber 10 and the activated luminal surface 14f of the optically clear wall 12f is essentially identical given the narrow distance 80 (in one embodiment described above, as little as 10 microns) between the luminal surface 14f of the optically clear wall 12f and the luminal surface 14d of the wall 12d opposite to the optically clear wall. In contrast, the efficiency of fluorescence excitation and collection from the surfaces other than the active surface of an open-top vessel lacking a vessel surface opposite to the active surface, or in assay chambers where the distance between the treated optically clear luminal surface and the surface of the opposite wall is greater than the depth of field of the optical system, for example, greater than about 5 millimeters, is much less than the efficiency of fluorescence from the active (treated optically clear luminal) surface of the chamber. In the instant chamber, the active surface is merely about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns from the opposite surface. Therefore, the depth 80 in the instant application is less than the depth of field of the optical system. Only the fluorescence emitted from the target analyte bound to the binding partners on the treated optically clear luminal surface and not the fluorescence of detector label non-specifically bound to other portions of the luminal surface of the chamber is relevant to accurately detecting the target analyte. When background fluorescence is also detected, accuracy and sensitivity of the assay directed to detection of the specific target analyte is severely compromised.

The introduction of a dye 60 that has particular characteristics into the assay chamber of the microfluidic device is yet an additional modification of the invention that is illustrated in FIG. 3 and described below. The introduced dye 60 attenuates the effect of background fluorescence 50 emitted by non-specific binding of the fluorescent detector molecules 52 to the luminal surface 14d of the wall 12d opposite to the optically clear wall 12f, but not the specific fluorescence 56 emitted by the fluorescent-labeled target analyte 54 that is specifically bound to the activated luminal surface 14f of the optically clear wall 12f.

In this embodiment of the invention, the sample and any unbound material including unbound fluorescent detector molecules are removed from the chamber and the chamber lumen is washed with a volume of wash solution exceeding or equal to the volume of the chamber lumen as described above. Next, an attenuating dye 60, as defined above, is introduced into the lumen of the chamber. The optimal concentration of the dye is the highest concentration of the dye that meets the following criteria: the dye must remain in solution under all conditions of transportation, storage and use and must not cause chemical or biochemical effects that alter the results of the assay. The dye solution volume is approximately equal to the volume of the chamber. In one embodiment, the attenuating dye may be included with the fluorescent detector molecules or, optionally, in the wash solution that is used to remove unbound fluorescent detector molecules and the sample from the chamber. The attenuating dye 60 includes such standard dyes as amaranth, erioglaucine, brilliant green or combinations of various standard dyes. Fluorescent labels include fluorescent molecules from common dye families derived from xanthene (e.g. Fluorescein, Texas Red), cyanine, naphthalene, coumarin, oxadiazole, pyrene, oxazine, acridine, arylmethine, tetrapyrrole and commercial dyes including TOTO-1, YOYO-1, Alexa Fluors, Cy family (e.g. Cy2, Cy5, Cy7) and many others, as well as fluorescent molecules useful in time-resolved fluorescence such as chelates of the lanthanides, europium, samarium, and terbium. Fluorescence 50 from the fluorescent detector molecules 52 that are non-specifically bound to the luminal surface of the chamber, for example, surface 14d, is “masked” by the one or more attenuating dyes 60 that are introduced into the chamber lumen. The specific fluorescence 56 of the fluorescent labeled target analyte 54 bound to the luminal surface 14f of the optically clear wall 12f is not masked. By masking non-specific fluorescence, that is the fluorescence arising from fluorescent detector molecules non-specifically bound to the wall opposite the optically clear wall in particular, the sensitivity and accuracy of the chamber 10 for detecting the target analyte is increased. Thus, measuring the concentration of the target analyte of interest is accomplished without the obscuring effect caused by the fluorescence 50 of non-specifically bound fluorescence detector molecules 52 on the measurement of the concentration of the target analyte reflected by the optical signal.

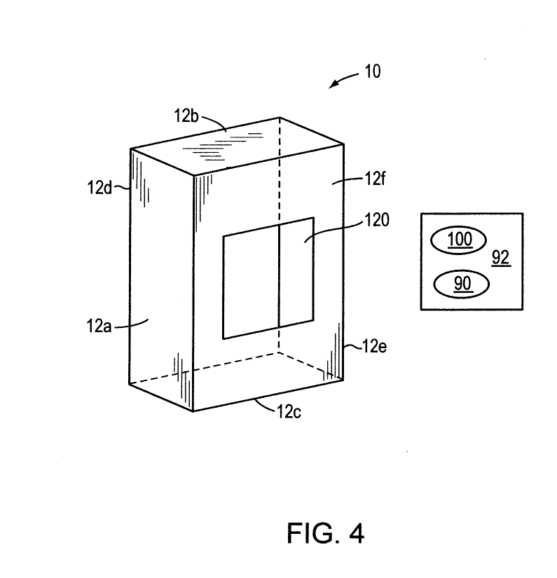

Referring to FIG. 4, in one embodiment according to the invention, the optics of the instrument are arranged to detect fluorescence only from the optically clear wall 12f or a portion of wall 12f and from the wall 12d opposite to the optically clear wall while not detecting fluorescence that may be emitted from the side walls or any other wall of the chamber 10.

For example, referring still to FIG. 4, in a rectangular assay chamber 10 according to the invention having a chamber depth of 0.1 mm and outside dimensions of 6 mm×2 mm, in one embodiment, the optically clear wall 12f of the chamber is 6 mm×2 mm. Referring still to FIG. 4, in this embodiment, only a 1 mm×1 mm optical signal portion 120 of the 6 mm×2 mm optically clear wall 12f, the center, for example, is utilized for the optical signal. Accordingly, the signal due to non-specific binding of the fluorescent detector molecules on wall surfaces such as the sides of the chamber other than the opposite wall surface 12d is substantially eliminated.

The outside dimensions of the chamber may be larger than the optically clear area which in turn may be larger than the portion used to make optical measurements.

### Exemplification

Myoglobin is an exemplary target analyte found in a biological specimen that may be detected in the microfluidic device according to the invention described above. Referring again to FIG. 2, the exemplary chamber is shallow having a depth 80, for example, of about 75 microns. A binding partner, a monoclonal antibody, for example, directed to a specific epitope of myoglobin may be used as the binding partner that is applied to the luminal surface 14f of the optically clear wall 12f. Another monoclonal antibody directed to a different epitope of myoglobin is labeled with a fluorescent detector molecule such as fluorescent chelates of europium. The fluorescently labeled monoclonal antibody is mixed with the biological specimen that may contain the myoglobin target analyte. After sufficient incubation time, the fluorescently labeled monoclonal antibody binds the myoglobin analyte to form a fluorescently labeled myoglobin target analyte. Without the addition of an attenuating dye, amaranth, for example, to the system, non-specific fluorescence from the luminal surface 14d of the opposite wall 12d caused by non-specific binding of the fluorescent detector molecule, and specific fluorescence from the binding of the fluorescently labeled myoglobin target analyte to the specific monoclonal antibody-binding partner on the luminal surface 14f of the optically clear wall 12f, is measured by an optical detector 100. The measured optical signal from the assay chamber 10 includes fluorescence 50 from non-specific binding of fluorescent detector molecules 52 to the untreated luminal surface 14d of the wall 12d and fluorescence 56 emitted by the fluorescent chelates of europium labeled myoglobin target analyte 55 specifically bound to the monoclonal antibody binding partner 57 on the luminal surface 14f of the optically clear wall 12f, leading to an artificially elevated fluorescence value that does not accurately reflect the concentration of myoglobin in the biological specimen. Following removal of unbound fluorescent detector molecules by a wash reagent without dye, the remaining non-specifically bound fluorescent detector molecules on the luminal surfaces of the chamber, particularly on the luminal surface 14d of wall 12d opposite the optically clear wall 12f of the shallow chamber, interfere with the true and specific optical signal emitted from the fluorescently labeled myoglobin target analyte bound to the specific monoclonal antibody binding partners on the luminal surface 14f of the optically clear wall 12f.

The method to detect the target analyte myoglobin, for example, as described above, preferably also incorporates the addition of an attenuating dye such as but not limited to amaranth, or combinations of dyes as described above. Referring to FIG. 3, in the preferred embodiment of the invention, the exemplary chamber is a shallow chamber having a depth 80, for example, of about 75 microns. After sufficient incubation to allow binding to occur, unbound fluorescent labeled monoclonal antibodies directed to the myoglobin target analyte are removed and the chamber lumen 16 is washed with a volume of wash reagent exceeding or equal to the volume of the chamber lumen. The wash reagent may contain or may be free of an attenuating dye, amaranth in this example, as described above with respect to FIG. 3. If the wash reagent does not contain the attenuating dye, the dye is added to the chamber lumen after the wash. In this exemplary embodiment, non-specific binding of fluorescent detector molecule to the untreated luminal surface 14d of the assay chamber 10 occurs, as discussed above with respect to FIG. 2. However, the amaranth dye 60 molecules positioned between the non-specifically bound fluorescent detector molecules 52 on the luminal surfaces 14d of the wall 12d opposite to the optically clear wall 12f, in particular, and the optical system 92 effectively attenuate the non-specific fluorescence. The application of amaranth in this example leads to an accurate determination of the specific fluorescence of the myoglobin target analyte 55 bound to the monoclonal antibody-binding partner 57 that is coated on the luminal surface 14f of the optically clear wall 12f.

In a preferred embodiment, the assay chamber 10 is a microfluidic element within a microfluidic assay device, in order to achieve the short incubation times and small sample and reagent volumes that are well-known characteristics of microfluidic assay devices. These characteristics can only be achieved if the assay chamber is kept shallow as disclosed above, preferably with depth 10-200 microns. If the assay chamber is excessively deep, mass transport by diffusion will require long incubation times, and filling and washing of the assay chamber will require larger volumes of costly reagents. However, referring again to FIG. 3, in order to achieve highly sensitive assays, it is also desirable to detect only the fluorescence from detector molecules specifically bound to the active treated luminal surface 14f of the optically clear 12f of the assay chamber 10, and not to detect the fluorescence from detector molecules non-specifically bound to the non-treated luminal surface 14d of the opposite wall 12d of the assay chamber 10. If the assay chamber is kept shallow as disclosed above, surface 14d and surface 14f will both be within the depth of field of practical optical systems that deliver the excitation light and collect the fluorescence. (While specialized optical designs to address this problem may be possible, they add cost, complexity, and risk of malfunction.) According to the invention, the use of attenuating dye resolves this fundamental conflict between microfluidic design and optical design.

In another embodiment according to the invention, a competitive binding assay may be performed. According to this embodiment, a binding partner for the target analyte is coated on the luminal surface of the optically clear wall, as described previously. Fluorescently labeled target analyte molecules are prepared that compete with the target analyte for binding specifically to the binding partner coated on the luminal surface of the optically clear wall. The fluorescently labeled target analyte molecules and the unlabeled analyte molecules in the sample compete to bind with the binding partner coated on the luminal surface of the optically clear wall. Thus, as the concentration of unlabeled analyte molecules in the sample increases, there is a corresponding decrease in the number of labeled molecules specifically bound to the binding partners coated on the luminal surface. Nevertheless, as is true for other embodiments discussed above, quantitation of unlabeled analyte in the sample is based on measurement of fluorescence from specifically bound fluorescent molecules on the luminal surface of the optically clear wall. Fluorescence from non-specifically bound fluorescent molecules on other surfaces within the depth of field of the optical system degrades the analytical performance of the assay, and the use of an attenuating dye according to the present invention resolves this problem.

### Specific Examples of Surface Fluorescence Attenuation:

For proof of principle, studies were conducted to determine the effect of various dyes in solution on attenuating non-specifically bound fluorescently labeled particles to the luminal surfaces, the surface opposite the optically clear surface in particular, of the assay chamber described above. For this study, latex nanoparticles labeled with fluorescent chelates of europium were directly added to the non-treated luminal surface 14d of the wall 12d opposite to the optically clear wall 12f of the chamber described above to simulate non-specifically bound fluorescent label that could occur during an actual diagnostic assay.

Latex nanoparticles labeled with fluorescent chelates of europium were dispensed directly onto the luminal surface of the wall opposite the optically clear wall of the polystyrene chambers (6 mm×2.5 mm×0.075 mm) described above. 1×10⁵, 1×10⁶ or 1×10⁷ nanoparticles were added to the surface in 1 uL aqueous buffer and allowed to air dry. An optically clear wall that was not treated was then ultrasonically welded onto the chamber to form the assay chamber 10 described above.

The lumen of each of the assay chambers described above was then washed three times with 100 uL of an aqueous solution without attenuating dye in order to remove loosely bound material on the luminal surface of the chamber. Fluorescence was measured after each wash using 340 nm excitation and collecting the emitted light using a 615 nm band pass filter. The amount of fluorescence from the luminal surface 14d of the wall 12d opposite the optically clear wall 12f was measured through the optically clear wall 12f. As shown in Table 1 below, although subsequent washes continued to remove additional fluorescence from the surface, the first three washes removed the majority of the loosely bound nanoparticles, as the fluorescence decreased 92% after the first wash. About 41% of the remaining counts were removed after the second wash, and only about 10% of the remaining counts were removed after the third wash (excluding the 1×10⁵ case in which the fluorescence actually increased slightly after the third wash, the decline was about 22% after the third wash).

Following the third wash, the assay chambers were then washed with 100 uL of wash reagent plus 7 mg/mL amaranth dye (CAS No: [915-67-3]), which strongly absorbs at 360 nm, near the wavelength used for excitation of fluorescent chelates of europium. In the presence of amaranth dye, the measured fluorescence was on average about 67% less than the measurements without dye, a decline that was too great to be explained solely by removal of additional fluorescent nanoparticles from the surface (although undoubtedly, a minor amount of additional loosely bound material was likely removed, see below). Rather, these results were interpreted as attenuation by the dye of the fluorescence arising from the nanoparticles bound to the surface 14d of the wall opposite (which is not an activated surface) the optically clear wall 12f.

This conclusion was supported by washing the chamber lumens a fifth time, this time again using a wash reagent without dye. After removal of the dye by a fifth wash, the fluorescence increased—an average of 2 fold—showing that the large decrease in fluorescence after the fourth wash with dye could not have been due solely to the removal of loosely bound nanoparticles from the surface 14d.

After the fifth wash the fluorescence did not return to the levels achieved after the third wash, indicating that additional loosely bound material was removed during the fourth and fifth washes. Assuming equal loses by removal of loosely bound material from the surface in each of these final two washes, the loss was estimated at about 19% per wash, similar to that seen from the third wash as shown below in Table I.

TABLE I
Attenuation of Surface-Bound Fluorescence by Amaranth Dye

| | Surface-Bound Fluorescence* | | |
|---|---|---|---|
| Nanoparticles | 1 × 10⁵ | 1 × 10⁶ | 1 × 10⁷ |
| Starting fluorescence | 99,346 | 1,162,483 | 8,000,834 |
| After 1st wash, no dye | 9,035 | 74,630 | 749,524 |
| After 2nd wash, no dye | 5,086 | 47,429 | 421,524 |
| After 3rd wash, no dye | 6,118 | 39,042 | 315,188 |
| After 4th wash + dye | 2,360 | 10,645 | 99,854 |
| After 5th wash, no dye | 3,739 | 23,497 | 214,367 |
| Attenuation | 61.4% | 72.7% | 68.3% |

*Maximum fluorescence measurements within the chambers.

As a further exemplification of the invention (See Table II), the above experiment was repeated with one of the following dyes added to the wash reagent: 1) 7 mg/mL amaranth (control); 2) 14 mg/mL amaranth; 3) 22.5 mg/mL erioglaucine (CAS No: [3844-45-9]); and 4) 30 mg/mL brilliant green (CAS No: [633-03-4]). Unlike amaranth which absorbs near the wavelength of the excitation light, erioglaucine and brilliant green absorb strongly near 615 nm, the fluorescence emission wavelength of chelates of europium. In this experiment, 2×10⁶ fluorescent nanoparticles were dispensed directly onto the luminal surface 14d of the wall opposite the optically clear wall 12f of polystyrene chambers as described above.

As illustrated in Table II below, with fluorescent particles attached to the luminal surface 14d of the wall 12d opposite the optically clear wall 12f, 63% attenuation of surface-bound fluorescence was observed using 7 mg/mL amaranth, similar to the level of attenuation observed above. Increasing the amaranth dye concentration from 7 mg/mL to 14 mg/mL resulted in even greater attenuation of fluorescence from the surface 14d, now at 77% reduction. When erioglaucine or brilliant green dyes were used, only about 2% of the surface-bound fluorescence was measured, indicating about 98% attenuation of the fluorescence bound to the luminal surface 14d of the wall 12d opposite to the optically clear wall 12f of the chamber in the presence of the these dyes at the concentration used.

As in the first exemplification described, after the fifth wash to remove the attenuating dye, a substantial increase of fluorescence was measured, again demonstrating that the attenuating dye blocked the fluorescence of the nanoparticles bound to the luminal surface 14d of the wall 12d opposite the optically clear wall 12f rather than removing them.

TABLE H
Attenuation of Surface-Bound Fluorescence with Additional Dyes
Percentage of Fluorescence Remaining After 3rd Wash

| Dye | 4th Wash + Dye | 5th Wash, No Dye |
|---|---|---|
| Amaranth (7 mg/mL) | 37% | 80% |
| Amaranth (14 mg/mL) | 23% | 66% |
| Erioglaucine (22.5 mg/mL) | 1.5% | 70% |
| Brilliant Green (30 mg/mL) | 2.1% | 42% |

First principles dictate that the magnitude of attenuation caused by dye molecule absorption should increase with increasing concentration of the dye. Indeed, this was observed with a doubling of the amaranth concentration (See Table II). Furthermore, high concentrations of erioglaucine and brilliant green blocked about 98% of the surface-bound fluorescence (See Table II). Subsequent removal of the dyes led to recovery of fluorescence, proving that the effect of the dyes was to block fluorescence from the surface-bound nanoparticles rather than removing the nanoparticles. This proof of principle experiment shows that it is possible to almost completely block the non-specifically bound fluorescence from the surface of the luminal wall opposite the optically clear wall by the application of an attenuating dye. As the results indicate, the choice of dye and concentration are important parameters affecting the magnitude of attenuation. The optimal concentration of the dye is the highest concentration of the dye that meets the following criteria: the dye must remain in solution under all conditions of transportation, storage and use and must not cause chemical or biochemical effects that alter the results of the assay.

According to one embodiment of a method of the invention for reducing the unwanted background fluorescence in an assay for measuring a target analyte in a biological sample, a microfluidic device having an assay chamber is provided. The assay chamber has a lumen enclosed by walls and an optional inlet and an outlet port. One chamber wall or alternatively, a portion of the chamber wall is optically clear for transmission of excitation and fluorescent light emitted from within the chamber to an optical detector outside the chamber for measuring the amount of fluorescence within the chamber.

The luminal surface or a portion of the optically clear wall of the chamber is coated (activated) with specific binding partners, as defined above, for a target analyte of interest in the biological sample. The luminal surface of the wall opposite the optically clear wall is untreated prior to initiating an assay.

The biological sample is mixed with a fluorescent detector molecule that includes another binding partner specific for the target analyte. This binding partner may be the same as or, optionally, different than the binding partner coated on the optically clear surface. The sample and the fluorescent detector molecule either individually or in combination are introduced into the lumen of the assay chamber. Alternatively, the sample is added to the chamber, the chamber is washed, followed by adding the fluorescent detector molecule to the chamber.

After incubation to allow binding, the solution including the biological sample and the fluorescent detector molecules are removed from the chamber. In one embodiment, the chamber is washed with a volume of wash reagent, such as an aqueous buffer, exceeding or equal to the volume of the chamber. The chamber is next filled with a volume of a solution such as an aqueous buffer, including one or more attenuating dyes. The dye solution volume is approximately equal to the volume of the chamber. Optionally, a wash solution may include the dye. The optical signal produced in the lumen of the chamber is measured by an optical detector while the attenuating dye is present in the chamber lumen and the optical signal is compared with a standard curve to determine the concentration of the target analyte in the sample.

The above described device and method can be used to reduce interfering signal arising from fluorescent detector molecules that non-specifically bind to non-treated luminal surfaces of diagnostic test devices of wide and varied designs, excluding the primary, optically clear, functionalized active reaction surface. Accordingly, the described device and method of the invention improves the accuracy sensitivity, manufacturing costs and minimizes use of costly reagents in fluorescence-based in vitro medical diagnostic tests thereby leading to improved patient care.

The invention may be embodied in other specific forms without departing from the spirit or essential characteristics thereof. The foregoing embodiments are therefore to be considered in all respects illustrative rather than limiting on the invention. Scope of the invention is indicated by the claims, and all changes that come within the meaning and range of equivalency of the claims are intended to be embraced.

We claim:

1. A method for attenuating non-specific fluorescence in a microfluidic device, comprising:
providing a microfluidic device having an assay measurement chamber comprising a first wall, wherein at least a portion of said first wall is optically clear, another wall opposite said first wall, and a lumen, the luminal surface of said first wall being coated with binding partners specific for a target analyte in a biological specimen;
introducing a fluorescent detector molecule comprising a binding partner for said target analyte into the chamber lumen;
introducing a solution comprising an attenuating dye;
wherein the attenuating dye absorbs light of a wavelength range selected from the group consisting of emission wavelength range, excitation wavelength range, or their combination of any said fluorescent detector molecule that is non-specifically bound to the luminal surface of the chamber.

2. The method of claim 1 wherein the binding partners coated on the luminal surface of said first wall comprise an intermediate binding partner.

3. The method of claim 1 wherein said attenuating dye comprises a combination of dyes.

4. The method of claim 1 wherein said luminal surface of said another wall is uncoated with a binding or a blocking agent.

5. The method of claim 1 wherein said first wall is entirely optically clear.

6. The method of claim 1 wherein a portion less than 100% of said first wall is optically clear.

7. The method of claim 1 wherein said fluorescent detector molecule is non-specifically bound to the luminal surface of said opposite wall.

8. The method of claim 1 further comprising washing the lumen of said chamber prior to introducing said fluorescent detector molecule into the chamber lumen.

9. The method of claim 1 further comprising washing said lumen with a wash reagent before introducing said dye.

10. The method of claim 9 wherein the volume of said wash reagent is the same as or exceeds the volume of said chamber.

11. The method of claim 1 further comprising washing said lumen with a wash reagent containing said attenuating dye.

12. The method of claim 1 wherein said chamber lumen is enclosed completely by at least a wall opposite the first wall and said first wall, and
introducing said target analyte through a chamber wall via a port.

13. The method of claim 11 wherein said washing step comprises introducing a wash reagent through an inlet port of said chamber and removing said wash reagent through an outlet port of said chamber.

14. The method of claim 1 wherein said binding partner of said fluorescent detector molecule comprises a first antibody specific for said target analyte, and said binding partner coated on the optically clear wall comprises a second antibody specific for said target analyte.

15. The method of claim 1 wherein said non-specifically bound fluorescent detector molecule is complexed with another molecule.

16. The method of claim 15 wherein the non-specific binding of the fluorescent detector molecule complex to the luminal surface of the chamber is mediated through said another molecule.

17. The method of claim 16 wherein the another molecule comprises a non-target analyte.

18. The method of claim 1 wherein optically measuring comprises measuring an optical signal arising from the luminal surface of the first wall.

19. The method of claim 12 wherein the distance between the first wall and the opposite wall is in the range of about 10 microns to 5.0 millimeters.

20. The method of claim 12 wherein the distance between the first wall and the opposite wall is in the range of about 75 microns.

21. The method of claim 12 wherein the distance between the first wall and the opposite wall is in the range of about 50 microns to 200 microns.

22. The method of claim 12 wherein the distance between the first wall and the opposite wall is in the range of about 75 microns to 100 microns.

23. The method of claim 1 wherein said dye comprises a dye selected from the group consisting of amaranth, erioglaucine, brilliant green, and combinations thereof.

24. A composition of matter, comprising:
a microfluidic device having an assay chamber for detecting a target analyte comprising a first wall wherein at least a portion of said first wall is optically clear, a wall opposite said first wall, and a lumen, said first wall coated on the luminal surface with binding partners specific for a target analyte in a biological specimen;
a fluorescent detector molecule comprising a binding partner for said target analyte;
a solution comprising a dye, the dye capable of absorbing the light of a wavelength range selected from the group consisting of emission wavelength range, excitation wavelength range, or their combination of any said fluorescent detector molecule that is non-specifically bound to the luminal surface of said chamber.

25. The composition of matter of claim 24 wherein said binding partner coated on said first wall comprises an antibody specific for said target analyte.

26. The composition of matter according to claim 25 wherein said binding partner of said fluorescent detector molecule comprises another antibody specific for said target analyte.

27. The composition of claim 24 wherein the distance between the first wall and the opposite wall is in the range of about 100 microns to 5.0 millimeters.

28. The composition of claim 24 wherein the distance between the first wall and the opposite wall is in the range of about 75 microns.

29. The composition of claim 24 wherein the distance between the first wall and the opposite wall is in the range of about 50 microns to 200 microns.

30. The composition of claim 24 wherein the distance between the first wall and the opposite wall is in the range of about 75 microns to 100 microns.

31. The composition of claim 1 wherein the binding partners coated on the luminal surface of said first wall comprise an intermediate binding partner.

32. The composition of claim 24 further comprising fluorescently labeled target analyte molecules.

33. The composition of claim 24 wherein said dye comprises a dye selected from the group consisting of amaranth, erioglaucine, brilliant green, and combinations of dyes.

34. The composition of claim 24 wherein said luminal surface of said opposite wall is uncoated with a binding or a blocking agent.

35. The composition of claim 24 wherein said first wall is entirely optically clear.

36. The composition of claim 24 wherein said fluorescent detector molecule is non-specifically bound to the luminal surface of said opposite wall.

37. A method for detecting the presence of a target analyte in a biological specimen, comprising:
providing a microfluidic device having an assay measurement chamber comprising a first wall, wherein at least a portion of said first wall is optically clear, another wall opposite said first wall, and a lumen, the luminal surface of said first wall being coated with binding partners specific for a target analyte in said biological specimen;
introducing the biological specimen into the chamber lumen;
introducing a fluorescent detector molecule comprising a binding partner for said target analyte into the chamber lumen;
introducing a solution comprising an attenuating dye;
wherein the attenuating dye absorbs light of a wavelength range selected from the group consisting of emission wavelength range, excitation wavelength range, or their combination of any said fluorescent detector molecule that is non-specifically bound to the luminal surface of the chamber;
optically measuring the fluorescent signal of the target analyte wherein the optical measurement is related to the target analyte concentration in the biological specimen.
